(19) United States
(12) Patent Application Publication
(10) Pub. No.: US 2023/0152510 A1
(43) Pub. Date: May 18, 2023

(54) VIRTUAL IMAGE OPTICAL SYSTEM, VIRTUAL IMAGE DISPLAY DEVICE, AND ON-BOARD SYSTEM, LATTER TWO INCLUDING VIRTUAL IMAGE OPTICAL SYSTEM

(71) Applicant: CANON KABUSHIKI KAISHA, Tokyo (JP)

(72) Inventors: Takayuki Sugiyama, Tochigi (JP); Hiroto Kano, Tochigi (JP)

(21) Appl. No.: 18/054,472

(22) Filed: Nov. 10, 2022

(30) Foreign Application Priority Data
Nov. 12, 2021 (JP) 2021-184899

(51) Int. Cl. F21V 8/00

(52) U.S. Cl. CPC G02B 6/0055

(57) ABSTRACT

A virtual image optical system with which a virtual image is formed by introducing light from a display surface to a pupil includes a first reflective surface arranged to reflect the light from the display surface, and a second reflective surface arranged to reflect light from the first reflective surface. An optical path length from the display surface to the second reflective surface is changeable with movement of the first reflective surface, a position of the pupil is changeable with rotation of the second reflective surface in a direction having a component in a direction perpendicular to an optical path of a principal ray incident on the pupil, and an angle formed between a moving direction of the first reflective surface and the principal ray incident on the first reflective surface is 5° or less.

### BACKGROUND

### Field of the Disclosure

The present disclosure relates to a virtual image system suitable for use in a virtual image display device for displaying a virtual image of an image.

### Description of the Related Art

In a known mobile apparatus such as a vehicle, a virtual image display device, for example, a Head-Up Display (HUD), is used which forms a virtual image of an image, displayed by a display, in a space, thus enabling an occupant (user) to visually recognize the image. With the virtual image display device, the image can be displayed in front of a vehicle windshield when viewed from the occupant and can be superimposed on a surrounding environment.

There is a possibility that, for instance, when the occupant tries to visually check a vehicle at a distance farther away than the virtual image, a visual point of the occupant is changed and good viewability cannot be obtained. Japanese Patent No. 6252883 and Japanese Patent Laid-Open No. 2018-31861 each disclose a virtual image display device capable of changing a relative position between the occupant and the virtual image by moving a movable mirror.

In the virtual image display devices disclosed in Japanese Patent No. 6252883 and Japanese Patent Laid-Open No. 2018-31861, however, an incident angle of a light ray from the display is greatly changed when the movable mirror is moved. Accordingly, a difference in brightness of the virtual image is caused between before and after the movement of the movable mirror, and the viewability for the occupant is reduced.

### SUMMARY

The present disclosure provides a virtual image optical system capable of realizing good viewability even with a simple configuration.

According to one aspect, the present disclosure provides a virtual image optical system with which a virtual image is formed by introducing light from a display surface to a pupil, the virtual image optical system including a first reflective surface arranged to reflect the light from the display surface, and a second reflective surface arranged to reflect light from the first reflective surface, wherein an optical path length from the display surface to the second reflective surface is changeable with movement of the first reflective surface, a position of the pupil is changeable with rotation of the second reflective surface in a direction having a component in a direction perpendicular to an optical path of a principal ray incident on the pupil, and an angle formed between a moving direction of the first reflective surface and the principal ray incident on the first reflective surface is 5° or less.

Further features of the present disclosure will become apparent from the following description of exemplary embodiments with reference to the attached drawings.

### BRIEF DESCRIPTION OF THE DRAWINGS

FIG. 1 is a schematic view of a virtual image display device (in a first state) according to one or more aspects of the present disclosure.

FIG. 2 is a schematic view of the virtual image display device (in a second state) according to one or more aspects of the present disclosure.

FIG. 3 is a schematic view of a virtual image display device according to a modification.

FIG. 4 illustrates a pair of partial schematic views of a virtual image display device according to Example 1.

FIG. 5 is a partial enlarged view of the virtual image display device according to Example 1.

FIG. 6 illustrates a pair of partial schematic views of a virtual image display device according to Example 2.

FIG. 7 is a partial enlarged view of the virtual image display device according to Example 2.

FIG. 8 is a schematic view of an on-board system and a mobile apparatus according to one or more aspects of the present disclosure.

### DESCRIPTION OF THE EMBODIMENTS

An embodiment of the present disclosure will be described below with reference to the drawings. The drawings are drawn in different scales from actual ones in some cases for the sake of convenience. In the drawings, the same members are denoted by the same reference signs, and duplicate description of those members is omitted.

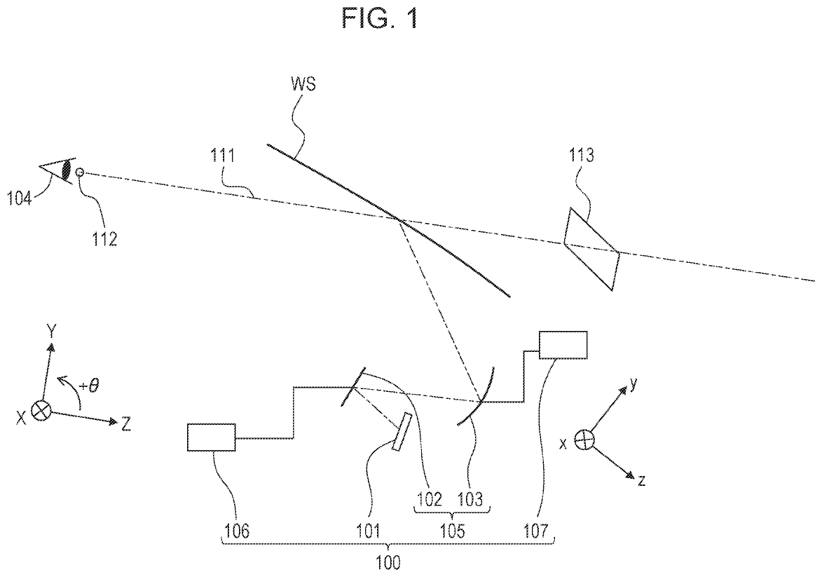

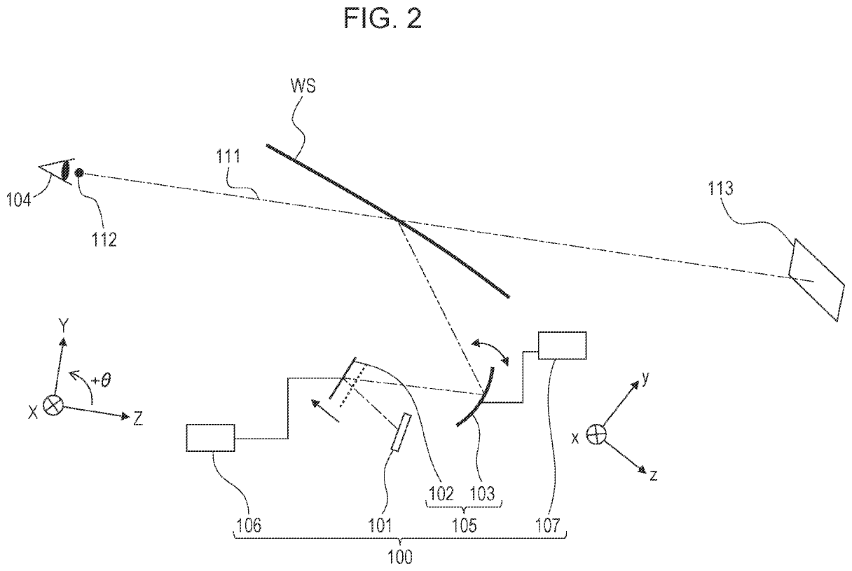

FIGS. 1 and 2 are schematic views (YZ-sectional views) of a virtual image display device 100 according to the embodiment of the present disclosure. The virtual image display device 100 includes a display (display unit) 101 for displaying an image, a virtual image optical system 105 for forming a virtual image 113 of an image displayed on a display surface of the display 101, and a driver (drive unit) for driving the virtual image optical system 105. FIG. 1 represents the case (first state) in which the virtual image 113 to be visually recognized by a user of the virtual image display device 100 is formed at a position closer to the user (i.e., a first position), and FIG. 2 represents the case (second state) in which the virtual image 113 to be visually recognized by the user is formed at a position farther away from the user (i.e., a second position).

In FIGS. 1 and 2, an optical path 111 (reference axis or optical axis) of a principal ray (reference ray) in a light flux from the display 101, the principal ray passing the center of a pupil on a reduction side (object side) of the virtual image optical system 105 and reaching the center of a pupil 112 (so-called Eye Box) on an enlargement side (image side), is denoted by a one-dot-chain line. Note that the principal ray does not in fact reach a position of the virtual image, but FIGS. 1 and 2 represent the optical path of an imaginary principal ray reaching the center of the virtual image 113 that is to be visually recognized by the user.

According to the virtual image display device 100, the virtual image 113 of the image displayed on the display surface of the display 101 is formed such that the user can visually recognize the formed image as if the formed image is displayed in front of a windshield WS. Thus, the formed image can be superimposed, for example, on a surrounding environment (external environment) in front of the windshield WS.

A display device (spatial modulation device), such as a liquid crystal panel, can be used as the display 101. For example, LCD (Liquid Crystal Display), LCOS (Liquid Crystal On Silicon), DMD (Digital Mirror Device), or the like can be used as the display 101. Alternatively, a screen for displaying an image projected by a projector (not illustrated) may be used. The display surface of the display 101 corresponds to an object plane (reduction plane) of the virtual image optical system 105.

In this embodiment, the display surface of the display 101 is arranged to be not perpendicular to the reference axis 111. Therefore, when sunlight or the like enters the display surface, the incident light can be avoided from being regularly reflected by the display surface and from reaching an eye 104 of the user. The display 101 is to be arranged such that the principal ray (reference ray) emerges from the center of the display surface. Such an arrangement can increase efficiency of light use in the virtual image display device 100.

The windshield WS is an optical member disposed in a mobile body (mobile apparatus), such as an automobile (vehicle), on which the virtual image display device 100 is mounted. The windshield WS not only reflects light from the virtual image display device 100 toward the eye 104 of the user (occupant of the mobile apparatus), but also transmits light from the exterior therethrough toward the user. A transmissive/reflective surface of the windshield WS may be a flat surface or a curved surface insofar as the windshield surface is in match with a shape of the mobile apparatus. A combiner (half mirror) that is a separate member from the windshield WS may be used as the optical member having the same function as the windshield WS. The virtual image display device 100 may introduce the light directly to the eye 104 of the user without passing through the windshield WS when necessary.

The virtual image optical system 105 according to this embodiment has a first reflective surface 102 (first reflective optical element) that reflects the light from the display 101, and a second reflective surface 103 (second reflective optical element) that reflects light from the first reflective surface 102. A mirror or a prism, for example, can be used as each of those reflective optical elements. The reflective surfaces may be each an aspheric surface, such as a free-form surface, when necessary. This embodiment supposes the configuration that one reflective surface is formed in one reflective optical element, but a reflective optical element having two or more reflective surfaces may also be used. For instance, a single reflective optical element having the first reflective surface 102 and the second reflective surface 103 may be used when necessary.

The virtual image optical system 105 may include other optical members, such as a refractive optical element, a reflective/refractive optical element, and a plate glass (cover glass), when necessary. The virtual image optical system 105 simply needs to have positive power in an entire system to form each virtual image and may have a non-power or negative power reflective surface. In an example, for reducing the size and weight of the entire system, the virtual image optical system 105 may simply consist of the first reflective surface 102 and the second reflective surface 103 as in this embodiment.

Features of the virtual image optical system 105 according to this embodiment will be described below.

The virtual image optical system 105 forms the virtual image 113 by introducing the light from the display surface of the display 101 to the pupil 112 through the first reflective surface 102 and the second reflective surface 103. In an example, the virtual image optical system 105 reflects the light from the display surface toward the enlargement side by the first reflective surface 102 and the second reflective surface 103 and introduces the light to the pupil 112 through the windshield WS. At that time, the user can visually recognize the virtual image 113 with the light reaching the eye 104 of the user at the position of the pupil 112.

The virtual image optical system 105 is configured to be able to change an optical path length from the display surface to the second reflective surface 103 with movement of the first reflective surface 102. According to such a configuration, a position at which the virtual image 113 is to be visually recognized by the user can be changed depending on change in the visual point of the user, and therefore good viewability can be given to the user. In this embodiment, the virtual image 113 can be moved in a direction along the optical path of the principal ray (i.e., a Z-direction) by moving, with a first driver 106 (moving mechanism) serving as the drive unit, the first reflective surface 102 in a direction having a component in a direction parallel to the optical path of the principal ray incident on the first reflective surface 102.

FIG. 1 represents the first state in which the virtual image display device 100 causes the user to visually recognize the virtual image 113 to be located at the first position. FIG. 2 represents the second state in which, by changing the position of the first reflective surface 102 relative to that in the first state, an optical path length from the display surface to the second reflective surface 103 is increased as compared with that in the first state. Corresponding to an increase in the optical path length from the display surface to the second reflective surface 103, an optical path length from the pupil 112 to the virtual image 113 is also increased in the second state as compared with that in the first state. Accordingly, the virtual image display device 100 can cause the user to visually recognize the virtual image 113 to be located at the second position farther away than the first position.

For instance, when the user looks at a nearby object (such as a vehicle in front) in trying to, for example, stop the mobile apparatus (namely, stop the vehicle), the virtual image display device 100 is to be brought into the first state. When the user looks at a faraway object (such as a traffic light or sign) while the mobile apparatus is moving at a high speed, for example, the virtual image display device 100 is to be brought into the second state. This can reduce a distance between an external object visually recognized by the user and the virtual image, and hence can reduce a burden exerted on the user who is going to change the visual line.

Here, unless the moving direction of the first reflective surface 102 is properly set, an incident angle of the light from the display surface is greatly changed with the movement of the first reflective surface 102, and the viewability for the user is reduced as described above. To cope with that point, in this embodiment, an angle α formed between the moving direction of the first reflective surface 102 and the principal ray incident on the first reflective surface 102 is set to be 5° or less. Under that condition, the moving direction of the first reflective surface 102 can be restricted to a direction substantially parallel to the principal ray, and therefore change in the incident angle of the light from the display surface can be reduced as compared with that in the case in which a is set to be larger than 5°. In other words, it is possible to reduce a difference in brightness of the virtual image 113 between before and after the movement of the first reflective surface 102, and to suppress reduction in the viewability for the user. If a is changed with the movement of the first reflective surface 102, a is to be held 5° or less at all times regardless of the position of the first reflective surface 102.

However, when the first reflective surface 102 is moved, a relative position between the pupil 112 and the eye 104 of the user is shifted. To cope with that point, the virtual image optical system 105 in this embodiment is configured to be able to change, with rotation (tilting) of the second reflective surface 103, the position of the pupil 112 in a direction having a component in a direction (Y-direction) perpendicular to the optical path 111 of the principal ray incident on the pupil 112. In this embodiment, the position of the pupil 112 can be moved in the Y-direction by rotating, with a second driver 107 (rotating mechanism) serving as the drive unit, the second reflective surface 103 about a rotation axis defined as an axis parallel to a direction (X-direction) that is perpendicular to a cross-section (YZ-cross-section) including the reference axis.

According to the above-described configuration, even when the relative position between the pupil 112 and the eye 104 of the user is shifted with the movement of the first reflective surface 102, that relative position can be adjusted with the rotation of the second reflective surface 103. Thus, since the position of the pupil 112 can be aligned with the position of the eye 104 of the user regardless of the position of the first reflective surface 102, good viewability can be given to the user regardless of the position of the virtual image 113.

This embodiment includes the first driver 106 and the second driver 107 each serving as the drive unit. For example, an actuator such as a motor, or an operating unit for non-electrically driving each of the reflective surfaces with operation by the user can be used as the drive unit. The drive unit can make switching between the above-described first state and second state by driving each reflective surface in accordance with a signal (information) from an external control unit. As an alternative, the drive unit may additionally have the function of the control unit. In such a case, the drive unit simply needs to include a processor such as a CPU (Central Processing Unit). This enables the drive unit to control the driving of each reflective surface.

From the viewpoint of further reducing the difference in brightness of the virtual image 113 between before and after the movement of the first reflective surface 102, a is set to be preferably 3° or less and more preferably 1° or less. In this embodiment, by setting α to 0°, the moving direction of the first reflective surface 102 is made parallel to the principal ray, and the difference in brightness of the virtual image 113 is reduced.

To adjust the position of the pupil 112 with high accuracy, a rotation center (rotation axis) of the second reflective surface 103 is to be positioned near an incident position of the principal ray on the second reflective surface 103. In this embodiment, the rotation center of the second reflective surface 103 is arranged at an intermediate position between the incident position of the principal ray on the second reflective surface 103 in the first state and the incident position of the principal ray on the second reflective surface 103 in the second state. When the position of the first reflective surface 102 is moved to a position different from those in the first and second states, the rotation center simply needs to be located (at an intermediate position) between respective incident positions of the principal ray on the second reflective surface 103 when the first reflective surface 102 is maximally moved to the reduction side and when it is maximally moved to the enlargement side.

When the sum of an incident angle and a reflection angle of the principal ray with respect to the first reflective surface 102 is denoted by β, the following inequality (1) is to be satisfied. When a value of β is different between the first state and the second state, the following inequality (1) is to be satisfied in each of the first and second states.

30°≤β≤70° (1)

If the value of β exceeds above an upper limit value of the inequality (1), a shift of the incident position of the principal ray on the second reflective surface 103 between before and after the movement of the first reflective surface 102 is increased, and an amount of rotation of the second reflective surface 103 necessary for adjusting the relative position between the pupil 112 and the eye 104 of the user is increased. Accordingly, the size of a space necessary for rotating the second reflective surface 103 is increased, which leads to a difficulty in reducing an overall device size, and an adjustment time of the second reflective surface 103 is prolonged. If the value of β exceeds below a lower limit value of the inequality (1), a spacing between the display 101 and the second reflective surface 103 is narrowed, thus causing a possibility that part of the light from the first reflective surface 102 may be blocked by the display 101.

Furthermore, the following inequality (1a) is preferably satisfied, and the following inequality (1b) is more preferably satisfied.

35°≤β≤65° (1a)

40°≤β≤60° (1b)

Moreover, when power of the first reflective surface 102 on the optical path of the principal ray is denoted by ϕ1 and power of the second reflective surface 103 thereon is denoted by ϕ2, the following inequality (2) is to be satisfied. When the power of each reflective surface is different between a cross-section (yz-cross-section) including the reference axis and a cross-section (xz-cross-section) perpendicular to the former cross-section, the following inequality (2) is to be satisfied in each of those two cross-sections.

0.00<|ϕ1/ϕ2|≤0.40 (2)

If the inequality (2) is not satisfied, the shift of the incident position of the principal ray on the second reflective surface 103 between before and after the movement of the first reflective surface 102 is increased. This implies the necessity of increasing the size of the second reflective surface 103 and a difficulty in reducing the overall device size.

Furthermore, the following inequality (2a) is preferably satisfied, and the following inequality (2b) is more preferably satisfied.

0.03≤|ϕ1/ϕ2|≤0.35 (2a)

0.05≤|ϕ1/ϕ2|≤0.30 (2b)

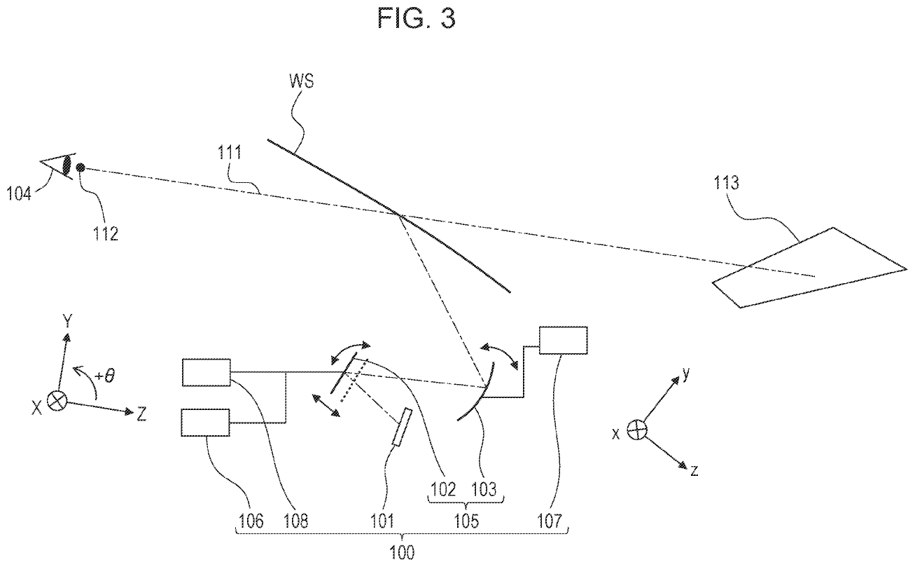

FIG. 3 is a schematic view (YZ-sectional view) of a virtual image display device 100 according to a modification of the above-described embodiment. Like FIG. 2, FIG. 3 also represents the case in which the virtual image 113 to be visually recognized by the user is formed at a position farther away from the user (i.e., a second position). This modification is different from the above-described embodiment in that the virtual image 113 can be tilted with rotation of the first reflective surface 102 relative to a straight line (the reference axis 111) connecting the center of the pupil 112 and the center of the virtual image 113. The virtual image display device 100 according to this modification includes a third driver 108 (rotating mechanism) serving as a drive unit to rotate the first reflective surface 102.

According to the above-described configuration, the virtual image 113 can be made not perpendicular to the reference axis 111, and the virtual image 113 can be suitably superimposed on an external situation when the user looks far away in the second state. Therefore, viewability of the virtual image 113 can be improved. On that occasion, to reduce a shift of an incident position of the principal ray on the first reflective surface 102 between before and after the rotation of the first reflective surface 102, a rotation center of the first reflective surface 102 is to be positioned on the optical path of the principal ray incident on the first reflective surface 102. The second reflective surface 103 is also to be able to adjust the relative position between the pupil 112 and the eye 104 of the user before and after the rotation of the first reflective surface 102.

When the virtual image display device 100 according to this embodiment is in the first state, the virtual image 113 is to be made perpendicular to the reference axis 111. This enables the virtual image 113 to be suitably superimposed on the external situation when the user looks near in the first state. Accordingly, the viewability of the virtual image 113 can be improved. When necessary, the virtual image 113 is made not perpendicular to the reference axis 111 in the first state as well.

Image information displayed on the display surface of the display 101 may be different between the first state and the second state. For instance, by changing the shape and the position of an image when the first and second states are switched from one to the other, a distortion and/or a shift of a center position of the image, and so on, caused by the switching can be suppressed. This can reduce uncomfortable feeling given to the user upon the switching between the first and second states. Particularly, when multiple virtual images with different inclinations relative to the reference axis are formed as in this modification, the image information is to be different between the first and second states.

The user in the first state and the user in the second state are not always the same person. For instance, when there are two or more users with different sitting heights, the switching between the first state and the second state may be performed by moving the first reflective surface 102 in response to change of the user.

When the relative position between the pupil on the enlargement side of the virtual image optical system 105 and the eye 104 of the user is shifted due to, for example, change of the user, change in posture of the user, and vibration of the mobile apparatus, the second reflective surface 103 may be rotated to compensate for the shift. In an example, the relative position between the pupil 112 and the eye 104 of the user may be adjusted by rotating the second reflective surface 103 with the second driver 107.

### Example 1

A virtual image display device 10 according to Example 1 of the present disclosure will be described below. Description of similar components in the virtual image display device 10 according to this Example to those in the virtual image display device 100 according to the above-described embodiment is omitted.

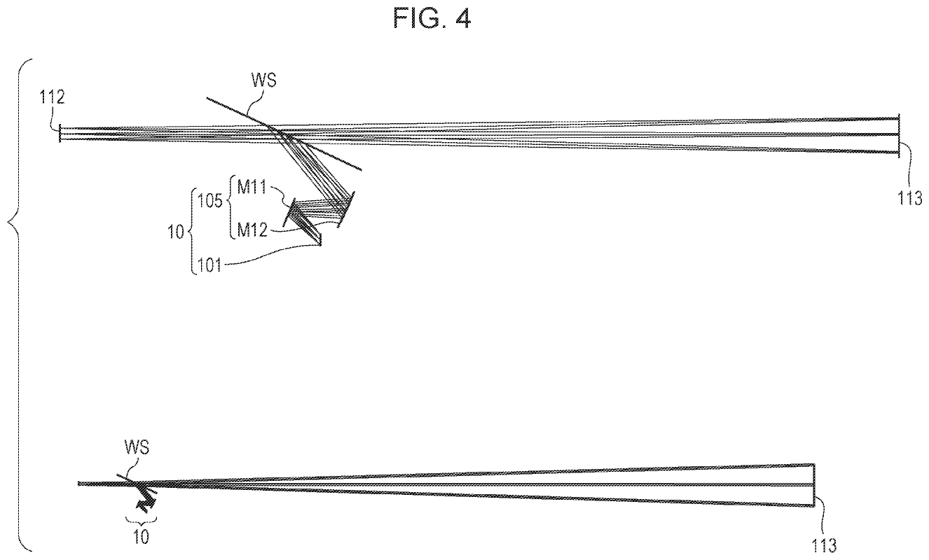

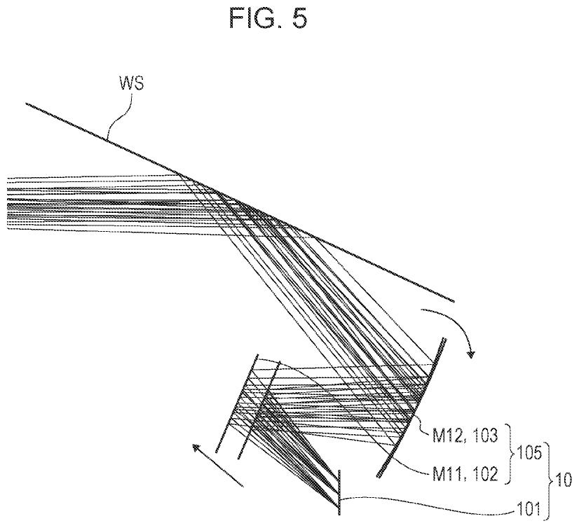

FIGS. 4 and 5 are partial schematic views of the virtual image display device 10 according to this Example. An upper drawing of FIG. 4 illustrates, in the first state, an optical path of light from the virtual image display device 10 until reaching a pupil 112 through the windshield WS and an imaginary optical path when the light from the virtual image display device 10 forms a virtual image 113. A lower drawing of FIG. 4 illustrates, in the second state, an optical path of the light from the virtual image display device 10 until reaching the pupil 112 through the windshield WS and an imaginary optical path when the light from the virtual image display device 10 forms the virtual image 113. FIG. 5 illustrates, in an enlarged scale, optical paths near a virtual image optical system in both the first and second states.

The virtual image optical system 105 according to this Example consists of a first reflective optical element (first mirror) M11 having a first reflective surface 102 and a second reflective optical element (second mirror) M12 having a second reflective surface 103. In the virtual image display device 10 according to this Example, a position of the virtual image 113 to be visually recognized by the user can be changed by changing an optical path length from the display surface to the second reflective surface 103 with movement of the first reflective optical element M11. Furthermore, in the virtual image display device 10, the relative position between the pupil 112 and the eye 104 of the user, having been shifted with the movement of the first reflective optical element M11, can be adjusted by changing the position of the pupil 112 with rotation of the second reflective optical element M12.

### Example 2

A virtual image display device 20 according to Example 2 of the present disclosure will be described below. Description of similar components in the virtual image display device 20 according to this Example to those in the virtual image display device 100 according to the above-described embodiment is omitted.

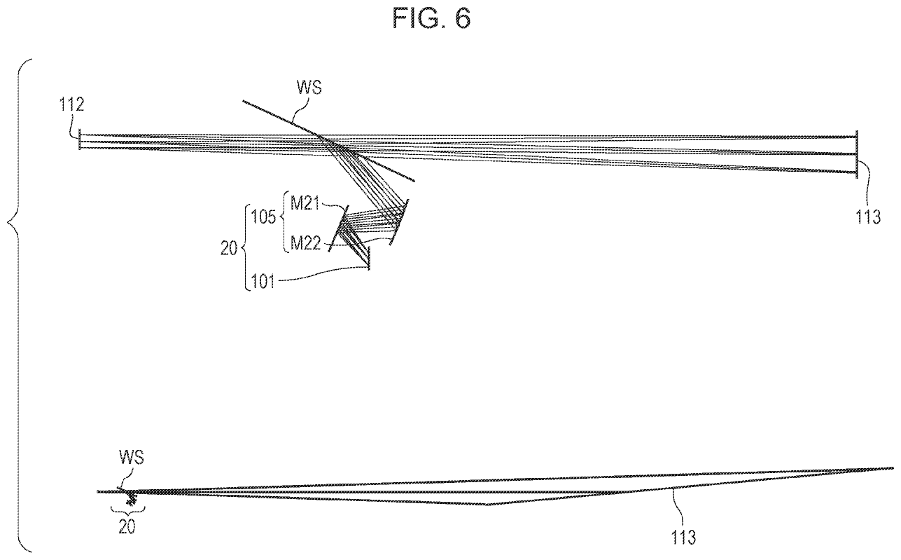

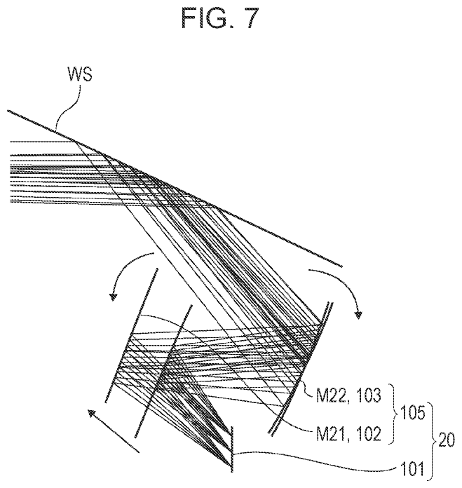

FIGS. 6 and 7 are partial schematic views of the virtual image display device 20 according to this Example. An upper drawing of FIG. 6 illustrates, in the first state, an optical path of light from the virtual image display device 20 until reaching a pupil 112 through the windshield WS and an imaginary optical path when the light from the virtual image display device 20 forms a virtual image 113. A lower drawing of FIG. 6 illustrates, in the second state, an optical path of the light from the virtual image display device 20 until reaching the pupil 112 through the windshield WS and an imaginary optical path when the light from the virtual image display device 20 forms the virtual image 113. FIG. 7 illustrates, in an enlarged scale, optical paths near a virtual image optical system in both the first and second states.

The virtual image optical system 105 according to this embodiment consists of a first reflective optical element (first mirror) M21 having a first reflective surface 102 and a second reflective optical element (second mirror) M22 having a second reflective surface 103. In the virtual image display device 20 according to this Example, as in the virtual image display device 10 according to Example 1, an optical path length from the display surface to the second reflective surface 103 can be changed with movement of the first reflective optical element M21, and a position of the pupil 112 can be changed with rotation of the second reflective optical element M22. Furthermore, in the virtual image display device 20, the virtual image 113 can be tilted with rotation of the first reflective optical element M21.

### Numerical Embodiments

Numerical data in Numerical Embodiments 1 and 2 corresponding to the above-described Examples 1 and 2 are as follows. In each of Numerical Embodiments, the surface number denotes the number i of a surface counting from the reduction side, and R denotes the curvature radius [mm] of a surface located at the i-th position (i.e., an i-th surface).

The virtual image optical system 105 according to each Example is an Off-Axial optical system. An optical axis (reference axis) of the virtual image optical system 105 is different between the first state and the second state. In consideration of the above point, to express a position and a tilt angle of each surface, an absolute coordinate system XYZ with a center of each of first and second pupils being the origin is defined. In an example, a normal line at the origin is supposed as a Z-axis, and a direction toward an image side from an object surface is supposed to be positive (i.e., +Z-direction). An axis passing the origin and forming 90° in a counterclockwise direction relative to the Z-axis in accordance with the definition of a right-handed coordinate system is supposed as a Y-axis. An axis passing the origin and being perpendicular to the Z-axis and the Y-axis is supposed as an X-axis, and a direction toward a back side of the drawing sheet of each figure is supposed to be positive (+X-direction).

In each numerical embodiment, a sign of the curvature radius R of the reflective surface is supposed to be positive when the reflective surface has a concave shape toward the reduction side (−Z-side) in the absolute coordinate system. Y and Z [mm] in each numerical embodiment denote coordinates of a surface vortex of each surface in the Y- and Z-directions in the absolute coordinate system. 0 [degree] denotes an inclination (tilt angle) of the normal line at the surface vortex of each surface when a direction rotating counterclockwise relative to the X-axis is defined to be positive.

Next, to express the shape of each surface, a local coordinate system xyz with an intersection between each surface and the Z-axis (reference axis) being the origin is defined. In an example, a normal line at the origin is supposed as a z-axis. An axis passing the origin and forming 90° in the counterclockwise direction relative to the z-axis in accordance with the definition of the right-handed coordinate system is supposed as a y-axis.

An axis passing the origin and being perpendicular to the z-axis and the y-axis is supposed as an x-axis, and a direction toward a back side of the drawing sheet of FIG. 1 is supposed to be positive (+x-direction). Here, when K denotes a conic constant, Cᵢⱼ denotes an aspheric coefficient, and R denotes a paraxial curvature radius, the shape of an aspheric surface can be expressed by the following formula. Note that “E±N” affixed to numeral values of the conic constant K and the aspheric coefficient Cᵢⱼ in each numerical embodiment indicate “×10^{±N}”.

$$z = \frac{\frac{{h}^{2}}{R}}{1 + \sqrt{1 - ( 1 + K ) {( \frac{h}{R} )}^{2}}} + \sum \sum {C}_{ij} {x}^{i} {y}^{j}$$

where h is expressed by the following formula.

h=\sqrt{x²+y²}

### Numerical Embodiment 1

Surface Data

| Surface | Number | R | Y | Z | θ |
|---|---|---|---|---|---|
| 1 | 101 | ∞ | 0.00 | 0.00 | −42.7 |
| 2 | M11 | ∞ | variable | variable | −20.0 |
| 3 | M12 | ∞ | 0.00 | 179.00 | variable |
| 4 | WS | ∞ | 147.84 | 2.81 | 73.0 |
| 5 | 112 | ∞ | 196.55 | 349.40 | 138.0 |
| 6 | 113 | ∞ | variable | variable | 138.0 |

Variable Amount Data

| First | State | Second | State |
|---|---|---|---|
| Y | M11 | 12.93 | 0.00 |
| Z | M11 | 151.97 | 179.00 |
| θ | M12 | −17.7 | −16.0 |
| Y | virtual image | 1668.64 | 6352.55 |
| Z | virtual image | −1285.52 | −6487.53 |

Aspheric Surface Data

| | M11 | M12 |
|---|---|---|
| K | 0.00E+00 | 0.00E+00 |
| C20 | 1.90E−04 | 6.72E−04 |
| C02 | −7.67E−05 | 5.16E−04 |
| C21 | −5.78E−06 | −8.07E−07 |
| C03 | −4.82E−06 | −6.94E−07 |
| C40 | 2.83E−09 | 1.46E−10 |
| C22 | 2.51E−08 | 7.67E−10 |
| C04 | 1.15E−08 | −2.77E−10 |

### Numerical Embodiment 2

Surface Data

| Surface | Number | R | Y | Z | θ |
|---|---|---|---|---|---|
| 1 | 101 | ∞ | 0.00 | 0.00 | −42.7 |
| 2 | M11 | ∞ | variable | variable | variable |
| 3 | M12 | ∞ | 147.84 | 2.81 | variable |
| 4 | WS | ∞ | 196.55 | 349.40 | 73.0 |
| 5 | 112 | ∞ | −338.75 | 943.92 | 138.0 |
| 6 | 113 | ∞ | variable | variable | variable |

Variable Amount Data

| First | State | Second | State |
|---|---|---|---|
| Y | M21 | 20.00 | 7.85 |
| Z | M21 | 143.27 | 190.52 |
| θ | M21 | −20.00 | −22.03 |
| θ | M22 | −19.20 | −16.00 |
| Y | virtual image | 1334.07 | 9698.21 |
| Z | virtual image | −913.94 | −10203.25 |
| θ | virtual image | 0.00 | 85.00 |

Aspheric Surface Data

| | M21 | M22 |
|---|---|---|
| K | 0.00E+00 | 0.00E+00 |
| C20 | −8.25E−05 | 6.29E−04 |
| C02 | −4.04E−05 | 5.33E−04 |
| C21 | −3.84E−06 | −6.09E−07 |
| C03 | −2.33E−06 | −3.63E−07 |
| C40 | 2.36E−09 | 2.31E−10 |
| C22 | 1.83E−08 | 1.99E−09 |
| C04 | −1.30E−09 | −1.47E−10 |

Numerical values related to the above-described inequalities in Numerical Embodiments 1 and 2 are listed in the following table.

TABLE 1

| | | Example | Example |
|---|---|---|---|
| | | 1 | 2 |
| α (degree) | | 0 | 0 |
| β (degree) | first state | 45 | 57 |
| | second state | 42 | 41 |
| \|ϕ1/ϕ2\| | xz-cross-section | 0.28 | 0.13 |
| | yz-cross-section | 0.15 | 0.08 |

### On-Board System and Mobile Apparatus

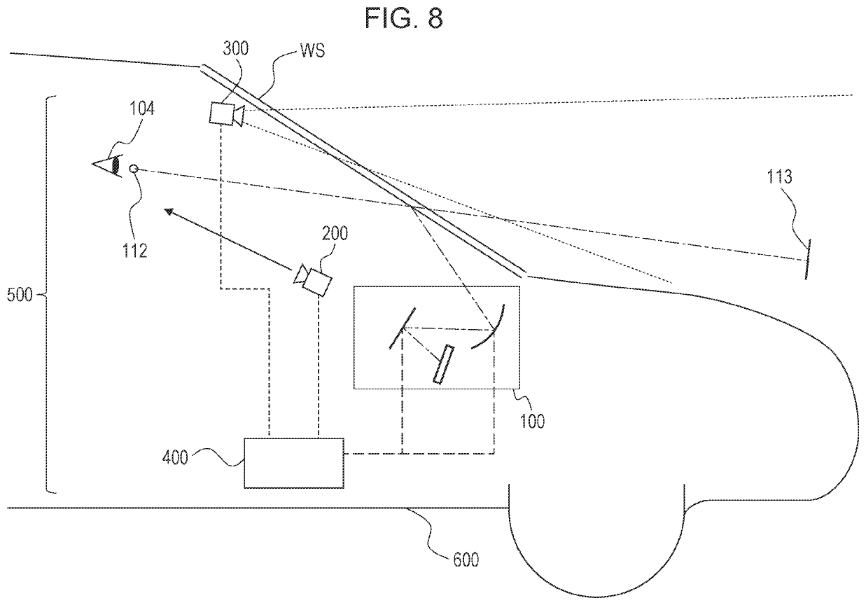

FIG. 8 is a schematic view of an on-board system 500 and a mobile apparatus 600 each including the virtual image display device 100 according to the embodiment. The on-board system 500 includes the virtual image display device 100, a second acquisition unit 300, and a control unit 400 and serves as a system for assisting a user (a passenger and a driver) of the mobile apparatus 600. The mobile apparatus 600 is a mobile body, such as an automobile, a ship, or an airplane, which installs the on-board system 500 thereon and is movable. FIG. 8 illustrates an automobile (vehicle) as an example of the mobile apparatus 600.

The first acquisition unit 200 acquires at least one of position information and visual point information of the user and is, for example, an image pickup apparatus such as a camera. The position information of the user is information related to a position of at least part of the user, for example, a position of an eye 104 of the user. The visual point information of the user is information related to a visual point or a visual line of the user, for example, a motion of the eye 104 (pupil) of the user.

The second acquisition unit 300 acquires external information (surrounding information) related to, for example, obstacles (including pedestrians and other vehicles) around the mobile apparatus 600 and a surrounding environment (landscape) and is, for example, an image pickup apparatus such as a camera. The second acquisition unit 300 in this embodiment is arranged to acquire the external information in front of the mobile apparatus 600, but it may be arranged to acquire the external information on the rear and/or the side of the mobile apparatus 600 in another example.

The control unit 400 controls the virtual image display device 100 and is, for example, a processor such as a CPU. The control unit 400 can control display of an image by the display 101 in the virtual image display device 100 and driving of the reflective surface by the drive unit. For instance, the control unit 400 can control the display of the image by the display 101 and the driving of each of the reflective surfaces by the drive unit in accordance with at least one of the information acquired by the first acquisition unit 200 and the information acquired by the second acquisition unit 300. The control unit 400 may be disposed inside the virtual image display device 100. Alternatively, the drive unit may further have the function of the control unit 400 as described above.

The first acquisition unit 200 can detect change in shift amount of the position of the user eye 104 relative to the mobile apparatus 600 and/or change in the visual line of the user by acquiring at least one of the position information and the visual point information of the user. The control unit 400 determines a driving amount of each reflective surface in the virtual image display device 100 based on the information acquired by the first acquisition unit 200 and drives each reflective surface by controlling the drive unit in accordance with the determined driving amount. Thus, the control unit 400 can change the position of the virtual image 113 and can compensate for the shift of the relative position between the eye 104 of the user and the pupil 112.

By controlling the driving of each reflective surface based on information (speed information) related to a moving speed of the mobile apparatus 600, the control unit 400 may further change the position of the virtual image 113 to be visually recognized by the user. For instance, display of the virtual image 113 appearing near and display of the virtual image 113 appearing far away can be switched by setting the position of the virtual image 113 to the first position when the mobile apparatus 600 is moving at a lower speed or is stopped (speed 0) and to the second position when it is moving at a high speed. This enables the user to visually recognize the virtual image in such a fashion that the position of the virtual image in an advancing direction of the mobile apparatus 600 is switched relative to the user, and hence can improve viewability of each virtual image when the speed of the mobile apparatus 600 is changed.

The control unit 400 may control the driving of each reflective surface by the drive unit in response to a signal that is output from an operation unit (not illustrated) upon operation of the operating unit by the user. Furthermore, even when the first acquisition unit 200 acquires information related to a position of any other part than the user eye 104, the control unit 400 can also determine the shift amount of the position of the user eye 104 relative to the mobile apparatus 600 based on the acquired information.

The control unit 400 further has the function as a determination unit for determining a possibility of collision with an obstacle (object). For instance, the control unit 400 determines the possibility of collision between the mobile apparatus 600 and the obstacle based on the external information acquired by the second acquisition unit 300. When the possibility of collision with the obstacle is determined to be present, the control unit 400 can issue warning to the user by, for example, instructing the virtual image display device 100 to display a warning message or the like.

When the possibility of collision with the obstacle is determined to be present, the control unit 400 may control the movement of the mobile apparatus 600 or may instruct various units of the mobile apparatus 600 to issue warnings. For instance, the control unit 400 can control the movement of the mobile apparatus 600 by outputting a control signal to a drive unit (such as an engine or a motor) in the mobile apparatus 600. The control may be performed by a method of, for example, applying the brake in the mobile apparatus 600, returning an accelerator, turning a steering wheel, or producing a control signal to generate braking force on wheels and suppressing output power of the drive unit. The warning may be issued by a method of, for example, generating warning sounds to the user, displaying warning information on a screen of a car navigation system or the like, or giving vibration to a seatbelt or the steering wheel.

While the embodiments and Examples of the present disclosure have been described above, the present disclosure is not limited to those embodiments and Examples, and various combinations, modifications, and alterations can be made within the scope of the gist of the present disclosure.

For instance, while the on-board system 500 according to the above-described embodiment includes one first acquisition unit 200 and one second acquisition unit 300, the on-board system 500 may include multiple first acquisition units 200 and multiple second acquisition units 300. Alternatively, a single acquisition unit with the functions of both the first acquisition unit 200 and the second acquisition unit 300 may be used. In another example, a unit of detecting, for example, vibration or acceleration of the mobile apparatus 600 may be disposed instead of the first acquisition unit 200 and the second acquisition unit 300, and the virtual image display device 100 may be controlled in accordance with information acquired by that unit.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-184899 filed Nov. 12, 2021, which is hereby incorporated by reference herein in its entirety.

What is claimed is:

1. A virtual image optical system with which a virtual image is formed by introducing light from a display surface to a pupil, the virtual image optical system comprising:
a first reflective surface arranged to reflect the light from the display surface, and
a second reflective surface arranged to reflect light from the first reflective surface,
wherein an optical path length from the display surface to the second reflective surface is changeable with movement of the first reflective surface,
a position of the pupil is changeable with rotation of the second reflective surface in a direction having a component in a direction perpendicular to an optical path of a principal ray incident on the pupil, and
an angle formed between a moving direction of the first reflective surface and the principal ray incident on the first reflective surface is 5° or less.

2. The virtual image optical system according to claim 1,
wherein the following inequality is satisfied:
30°≤β≤70°
where sum of an incident angle and a reflection angle of the principal ray with respect to the first reflective surface is denoted by β.

3. The virtual image optical system according to claim 1,
wherein the following inequality is satisfied:
0.00<|ϕ1/ϕ2|≤0.40
where power of the first reflective surface on the optical path of the principal ray is denoted by ϕ1 and power of the second reflective surface thereon is denoted by ϕ2.

4. The virtual image optical system according to claim 1,
wherein a rotation center of the second reflective surface is positioned between an incident position of the principal ray on the second reflective surface when the first reflective surface is maximally moved to a reduction side and an incident position of the principal ray on the second reflective surface when the first reflective surface is maximally moved to an enlargement side.

5. The virtual image optical system according to claim 1,
wherein the virtual image is tiltable with rotation of the first reflective surface relative to a straight line connecting a center of the pupil and a center of the virtual image.

6. The virtual image optical system according to claim 5,
wherein a rotation center of the first reflective surface is positioned on the optical path of the principal ray incident on the first reflective surface.

7. A virtual image display device comprising:
the virtual image optical system according to claim 1;
a display unit with a display surface; and
first and second drive units configured to drive the first and second reflective surfaces, respectively.

8. The virtual image display device according to claim 7,
wherein the first drive unit changes a position of the virtual image to be visually recognized by a user by moving the first reflective surface.

9. The virtual image display device according to claim 7,
wherein the second drive unit adjusts a relative position between the pupil and an eye of a user by rotating the second reflective surface.

10. The virtual image display device according to claim 7,
wherein at least one of the first and second drive units drives at least one of the first and second reflective surfaces in accordance with at least one of position information and visual point information of a user.

11. An on-board system comprising:
the virtual image display device according to claim 7, the on-board system being installed on a vehicle.

12. The on-board system according to claim 11, further comprising:
a first acquisition unit configured to acquire at least one of position information and visual point information of a user,
wherein at least one of the first and second drive units drives at least one of the first and second reflective surfaces in accordance with the information acquired by the first acquisition unit.

13. The on-board system according to claim 11,
wherein at least one of the first and second drive units drives at least one of the first and second reflective surfaces in accordance with information related to a moving speed of the vehicle.

14. The on-board system according to claim 11, further comprising:
a second acquisition unit configured to acquire external information.

15. The on-board system according to claim 14, further comprising:
a determination unit configured to determine a possibility of collision between the vehicle and an object based on the information acquired by the second acquisition unit.

16. The on-board system according to claim 15,
wherein the virtual image display device issues warning to a user when the possibility of collision between the vehicle and the object is determined to be present by the determination unit.

17. A mobile apparatus comprising:
the virtual image display device according to claim 7,
the mobile apparatus installing the virtual image display device thereon and being movable.

18. The mobile apparatus according to claim 17, further comprising:
an optical member arranged to reflect light from the virtual image display device toward a user.

19. The mobile apparatus according to claim 18,
wherein the optical member transmits light from exterior therethrough toward the user.
